(19) United States
(12) Patent Application Publication
(10) Pub. No.: US 2002/0102362 A1
(43) Pub. Date: Aug. 1, 2002

(54) Process for providing permanent, solvent and caustic proof, multi-colored sample identification markings directly onto glass laboratory container surfaces

(76) Inventor: Jinghua Schneider, Gurnee, IL (US)

Correspondence Address: BANNER & WITCOFF, LTD., TEN SOUTH WACKER DRIVE, SUITE 3000, CHICAGO, IL, 60606, US

(21) Appl. No.: 10/062,605

(22) Filed: Jan. 31, 2002

Related U.S. Application Data
(60) Provisional application No. 60/265,342, filed on Feb. 1, 2001.

(51) Int. Cl. B05D 3/00; B05D 5/00

(52) U.S. Cl. 427/555; 427/271

(57) ABSTRACT

A method for making laboratory containers includes designating an area for the container label, applying a ceramic base coating material in that area, the coating and the container having a very similar coefficient of thermal expansion, and then etching the label area with a laser.

### CROSS REFERENCE TO RELATED APPLICATION

This is to the utility application based upon previously filed provisional application Ser. No. 60/265,342 filed Feb. 1, 2001 and entitled Process for Providing Permanent Solvent Resistant Sample Identification Markings Directly onto a Laboratory Container Surface which is incorporated herewith by reference and for which priority is claimed.

### BACKGROUND OF THE INVENTION

In a principal aspect the present invention relates to a means for marking laboratory sample containers and apparatus in a manner which is permanent while at the same time providing a marking which resists alteration.

Chemical and pharmaceutical laboratories consistently utilize glass containers to transfer fluids and materials when conducting experiments. Additionally glass laboratory items are used to convey and store chemicals and various other types of reactants and materials useful in research. The necessity to mark such containers for purposes of control, evaluation, and inventory is obvious.

One current method for maintaining a record and identifying items in a container is to print alphanumeric or bar codes onto paper or on synthetic films or labels that are attached to the containers. The labels typically include adhesive or some other material on one side to facilitate holding the label onto the outside surface of the container or laboratory apparatus made of plastic or glass. This method of identifying materials in a laboratory apparatus or container has certain disadvantages including:

1. Low solvent resistance (that may vary based upon the label material and adhesive material) for the label rendering the label susceptible to the disadvantage of being accidentally removed from the apparatus or container, and

2. Degradation of the adhesive material or label over time or due to temperature thereby causing the label to disintegrate or otherwise be lost.

3. Weight gain or loss of these types of labels over time under various storage conditions.

Alternative systems involve printing or chemical etching processes which provide permanent solvent resistant markings directly onto a container. Such methods and processes, however, are designed to provide the same markings onto a bulk quantity of containers or racks and are not considered to be economically practical for marking each individual container with a distinct or sequential mark as often needed or required in a laboratory setting. Thus there has developed a need to provide an improved method for marking laboratory containers made from plastic or glass or a combination thereof.

### SUMMARY OF THE INVENTION

Briefly, the present invention comprises a method for marking laboratory containers made from glass which includes the steps of (1) selecting an area of the outside surface of the container, (2) applying a layer of a ceramic paint coating material over that selected area wherein the coefficient of thermal expansion of the ceramic material used for the coating is substantially the same as the coefficient of thermal expansion of the container material in the area designated, and then (3) imprinting indicia onto the ceramic coating with a laser emitting device to permanently etch a code in the coating by, for example, effecting a color change in that coating. Various coating materials may be utilized in combination with various laser or equipment devices for changing or etching the coating material. The area selected for placement of indicia, bar code or the like may by chosen with a specific geometry to enhance visibility and utility.

Thus it is an object of the invention to provide an improved method for marking a laboratory container surface.

It is a further object of the invention to provide a method for a permanent solvent, caustic temperature and scratch proof marking or identification on a container.

Another object of the invention is to provide identification systems which cannot be removed, which are highly legible, and which are inexpensive.

Another object of the invention is to provide a marking system which is not subject to changes in weight.

These and other objects, advantages and features of the invention will be set forth in the detailed description which follows.

### DESCRIPTION OF THE PREFERRED EMBODIMENT

A laboratory container such as a glass vial is chosen and the coefficient of thermal expansion of the glass is determined. In general coefficient of expansion for lab glass is called 33 and 51 type. Thereafter a ceramic based paint and preferably a white ceramic based paint such as used in ceramic glass decorating and which has a coefficient of thermal expansion substantially the same as the glass is applied to a predetermined geometric area of the glass container. An example of a container having such a coating in a certain fixed area of the glass container is provided by the firm if Kimble Kontes and Wheaton Scientific Co. in N.J.

Alternatively, glassware may have white colored ceramic paint applied thereto, for example, by screen printing, pad printing, or spray printing wherein the ceramic paint is fired once applied at a temperature in the range of about 1100° F. to enhance chemical bonding to the glass. Preferably nonlead ceramic paints are utilized inasmuch as they are believed to be preferred for laboratory use and in the laboratory environment. Nonlead ceramic paints are will change color from a white color to a brown color when exposed to a laser beam. The resultant brown color is stable and inert. Further, the area of such a white ceramic nonlead paint when not exposed to a laser will remain as a white color. Glass containers with nonlead ceramic paint which are white in color can be supplied by Morgan Meredith, Inc.

Nonlead ceramic paints produce a darker brown color when exposed to a laser beam. This enables bar codes that are produced in this manner to be more easily read by bar code scanners (readers). Alternately, other ceramic paints which do not produce a brown color when exposed to a laser beam can still be marked since the laser beam will remove the paint and the underlying glass will have a frosted appearance. A bar code produced in this manner can also be read by a bar code scanner (reader) and has all of the desirable characteristics mentioned above.

Once having obtained the glassware, or glass apparatus having an area with a ceramic paint coating, the coating is exposed to a laser beam. Various types of laser beams may be utilized. The beam is, however, focused upon the ceramic patch or layer and a bar code, numeric code, or alphabetic code or combinations thereof may be printed on the label. The laser beam interacts with the ceramic coating causing it to change color or frosted appearance (for glass). An example of such a laser beam device is made by Domino and identified as CO₂ laser coader GGM-1S with a 125 mm lens. The laser power setting for such a device may be varied from 1 percent to 90 percent. For example, the above identified laser may be set at 7 percent power for a glass tube wherein the movement of the beam is at 3 inches per second with a resolution of 150. The laser coding device is preferably equipped with appropriate software package for sequential and one dimensional and two dimensional bar codes.

As mentioned previously, the marking area will have a particular shape such as a square, rectangle, or a circular shape. Each of the label areas or designated areas may be printed individually and easily and quickly to provide a unique code for the contents of the glass container or apparatus. This process can be easily automated for an additional savings of time and expense.

By using the invention paper, film, and other adhesive bonded labels are no longer required. The labeling approach is solvent, caustic, temperature and scratchproof, inexpensive, and quick, easily automated and not subject to weight change. The labels will, in effect, remain intact and permanent after autoclaving or subjected to other chemical, heat, or pressure processing. Storage at various temperatures is also possible with such labeling. Additionally, large expanses of space are not required to provide a legible and easily used label area. Labels can be located on bottoms, caps, and other small areas of a container not easy with paper adhesive labels. [fix this] With the process of the invention, the ceramic paint may be applied to the container just shortly before application of the laser energy thereto for ease of automation. This provides for greater flexibility with respect to the use and utility of the containers. The labels are thin and will not rub off of the container or alter dimensions thereby enabling use of items so labeled in automated equipment lines without special adjustment.

Various other permutations and combinations of the materials and process step may be utilized. For example, other coatings such as epoxy paint and glass paints may be used. Ceramic materials are preferred since they chemically bond to the glass. The indicia may be one or two dimensional. The coating may change color or be removed by the laser. The invention is therefore to be limited only by the following claims and equivalents thereof:

What is claimed is:

1. A method for making laboratory items of the type made from a material selected from the group consisting of glass and plastic comprising the steps of:
(a) selecting an area of the outside item surface;
(b) applying a layer of a ceramic paint coating material having a coefficient of thermal expansion substantially the same as the coefficient of thermal expansion of the item material onto the area; and
(c) imprinting indicia onto the ceramic coating with a laser emitting device to permanently etch a code in said coating by effecting a color change to the coating.

2. The process of claim 1 wherein the indicia are selected from the group consisting of bar code, numeric code, and alphabetic code.

3. The process of claim 1 wherein the coating is selected from the group consisting of lead ceramic paint and nonlead ceramic paint.

4. The process of claim 1 including firing of the ceramic coating onto the glass.

5. A product by the process of claims 1, 2, 3 or 4.
